(19) United States
(12) Patent Application Publication
(10) Pub. No.: US 2005/0122488 A1
(43) Pub. Date: Jun. 9, 2005

(54) Portable digital visual presenter specially designed to be used with 14 x 17 inches films on which the MRI and CAT scans are commonly printed

(76) Inventor: Alberto Angel Fernandez, Montevideo (UY)

Correspondence Address: ALBERTO ANGEL FERNANDEZ DELL'OCA, DEAUVILLE 1781, MONTEVIDEO, 11.500, UY

(21) Appl. No.: 10/728,861

(22) Filed: Dec. 8, 2003

(51) Int. Cl. G03B 21/00

(52) U.S. Cl. 353/120

(57) ABSTRACT

A Portable Digital Visual Presenter specially designed to be used with 14×17 inches films on which the MRI and CAT scans are commonly printed. The present invention allows the whole film (commonly including between 8 and 50 images) and each individual image to be included in the shooting area of the digital camera, making the use simple, and friendly. The position of the film with respect to the digital camera is variable in order to allow each individual image to be situated at the centre of the camera's shooting area, fulfilling the said camera's shooting area. Since each member can be folded, it is possible to make the Portable Digital Visual Presenter compact so that users can conveniently carry such a novel Portable Digital Visual Presenter to different conference rooms.

### BACKGROUND OF THE INVENTION

The present invention relates generally to the field of Visual Presenters and more particularly to Portable Digital Visual Presenter to be used with 14×17 inches films on which the MRI and CAT scans are commonly printed.

CAT (Computerized Axial Tomography) and MRI (Magnetic Resonance Image) scans are widely used in medicine today. Results are commonly printed in a 14×17 inches film, wherein said film includes up to 50 individual images.

The analysis of MRI and CAT scan's results in order to make a medical report is not easy for more than two people because of the small dimension of each printed image. Teaching or discussion in clinical sessions is even more difficult because of the same problem.

During meetings and lectures, Digital Visual Presenter units are often used to project transparent slides, overheads, X-rays and all kind of objects that have an adequate size to be positioned in its flat upper surface (commonly called stage) onto a screen or wall when used in conjunction with a data/video projector. The projection and resultant enlargement of these images onto the screen allows image presentation to a large audience improving the quality of teaching and discussion in clinical sessions. Used in conjunction with an XGA 1024×768 dpi resolution projector, the Digital Visual Presenter is of great help when it is necessary to resolve the detail on certain objects. However, with the actual state of art, there is not a practical way to view the complete 14×17 inches film on which the MRI and CAT scans are commonly printed, and each single image included in said film in great detail (full screen size when the image projected) with a portable unit.

### BRIEF SUMMARY OF THE INVENTION

Therefore, an object of the present invention is to provide a portable and easy to handle Digital Visual Presenter wherein the images included in the 14×17 inches films on which the MRI and CAT scans are commonly printed, are viewed in a simple and practical way. It is another object of the present invention to view all kind of x-ray films and objects that have an adequate size to be positioned in the stage of the Digital Visual Presenter.

By fulfilling the recently mentioned objects, the present invention is of extremely help to the individual medical care, research and teaching areas.

One embodiment of the novel Digital Visual Presenter provides: a digital camera with at least XGA resolution (1024×768 dpi), a shooting area of at least 14×17 inches, and which allows the individual images included in the film, that are situated in the centre of the camera shooting area, to fulfil the said camera shooting area so that they can be seen in full screen size when the image is projected; a housing with a width of 410 mm, and a length of 450 mm, comprising a back lighted flat upper surface for the 14×17 inches films, on which MRI and CAT scans are commonly printed, to be adequately positioned on it, and a friction minimized floor which allows the sliding mechanism to move easily, making all the system to work smoothly; a telescopic arm part to which the digital camera is attached; a sliding mechanism wherein the said arm is mounted into and which allows the digital camera to move along the y-axis and x-axis of the flat upper surface so that the centre of the digital camera's shooting area reaches every sector of said stage; a laser pointer attached to the digital camera to determine exactly where in the flat upper surface the digital camera's shooting area centre is positioned; two lamps on arm attached to both sides of the housing; wherein the housing, the digital camera, the arm part and the two lamps on arm can be folded in order to make the Digital Visual Presenter portable.

Another embodiment of the novel Digital Visual Presenter provides: a digital camera with at least XGA resolution (1024×768 dpi), a shooting area of at least 14×17 inches, and which allows each individual image on the film, that is situated in the centre of the camera shooting area, to fulfil the said camera shooting area so that they can be seen in full screen size when the image is projected; a housing of a width of 630 mm, and a length of 850 mm, comprising a back lighted flat upper surface, a telescopic arm part to which the digital camera is attached; a laser pointer attached to the digital camera to determine exactly where in the flat upper surface the digital camera's shooting area is positioned; two lamps on arm attached to both sides of the housing; wherein the housing, the digital camera, the arm part and the two lamps on arm can be folded in order to make the Digital Visual Presenter portable.

In this second embodiment, the stage dimensions are calculated to allow the 14×17 inches film on which the MRI and CAT scans are commonly printed, to be moved in all directions over the stage by the user of the Digital Visual Presenter. As a consequence, each individual image on said film can be situated in the centre of the camera shooting area, fulfilling the said camera shooting area so that they can be seen in full screen size when the image is projected.

A credit card size wireless remote control that is stored in the Digital Visual Presenter's housing is included in both embodiments. This remote controller allows the user to adjust the image settings such as zoom, brightness, colour and contrast and it has a built-in laser pointer which is of great help for the user when giving a presentation. A handle is also included in both embodiments so that the user of the present invention can carry such a Portable Digital Visual Presenter to different conference rooms in an easy an practical way.

Other objects, advantages and novel features of the present invention will become apparent from the following detailed description of the invention when considered in conjunction with the accompanying drawings.

### BRIEF DESCRIPTION OF THE SEVERAL VIEWS OF THE DRAWINGS

FIG. 1 is a perspective view of the first embodiment of the Portable Digital Visual Presenter of the invention in a using state wherein the telescopic arm part is completely extended.

FIG. 2 is a front view of FIG. 1.

FIG. 3 is a transparent left side view of FIG. 1 showing the control box with all the ports.

FIG. 4 is a right side view of FIG. 1 showing the housing's groove and the sliding mechanism positioned into it.

FIG. 5 is an exploded transparent perspective view of FIG. 1 wherein the light bulbs are removed to clearly show the sliding mechanism, which allows the camera to reach every single area of the flat upper surface.

FIGS. 6A, 6B and 6C show the first embodiment of the Portable Digital Visual Presenter of the invention in a using state, wherein the centre of the digital camera's shooting area is positioned in three different images of the 14×1 7 inches film on which the MRI and CAT scans are commonly printed.

FIG. 7 is a top view of the first embodiment of the Portable Digital Visual Presenter of the invention in a collapsed, transportable state.

FIG. 8 is a perspective view of a Portable Digital Visual Presenter in a using state, according to a second embodiment of the present invention, wherein the telescopic arm part is completely extended FIG. 9 is a front view of FIG. 8.

FIG. 10 is a left side view of FIG. 8.

FIG. 11A, 11B and 11C show the second embodiment of the Portable Digital Visual Presenter of the invention in a using state, wherein the 14×1 7 inches film, on which the MRI and CAT scans are commonly printed, is positioned in three different places of the flat upper surface.

FIG. 12 is a top view of the second embodiment of the Portable Digital Visual Presenter of the invention in a collapsed, transportable state.

### DETAILED DESCRIPTION OF THE INVENTION

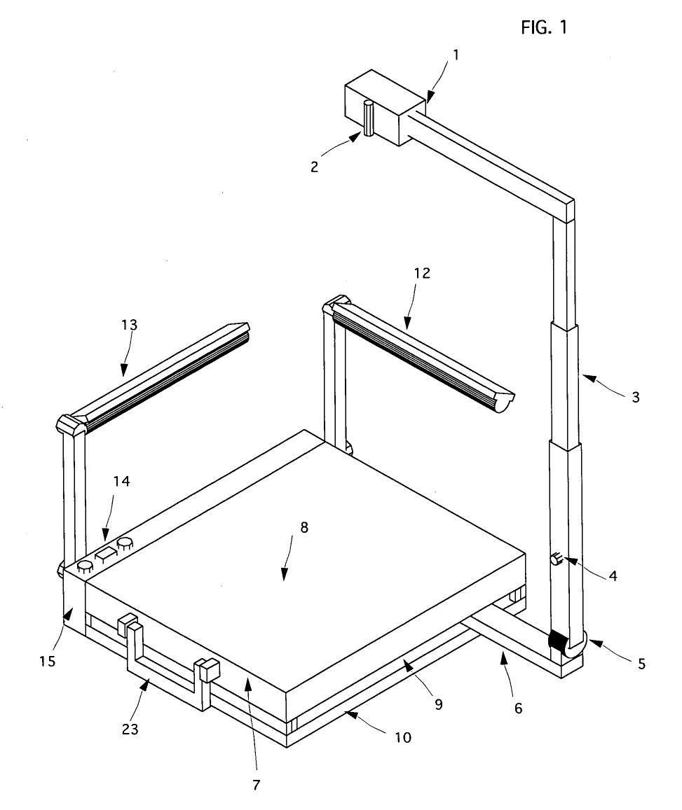

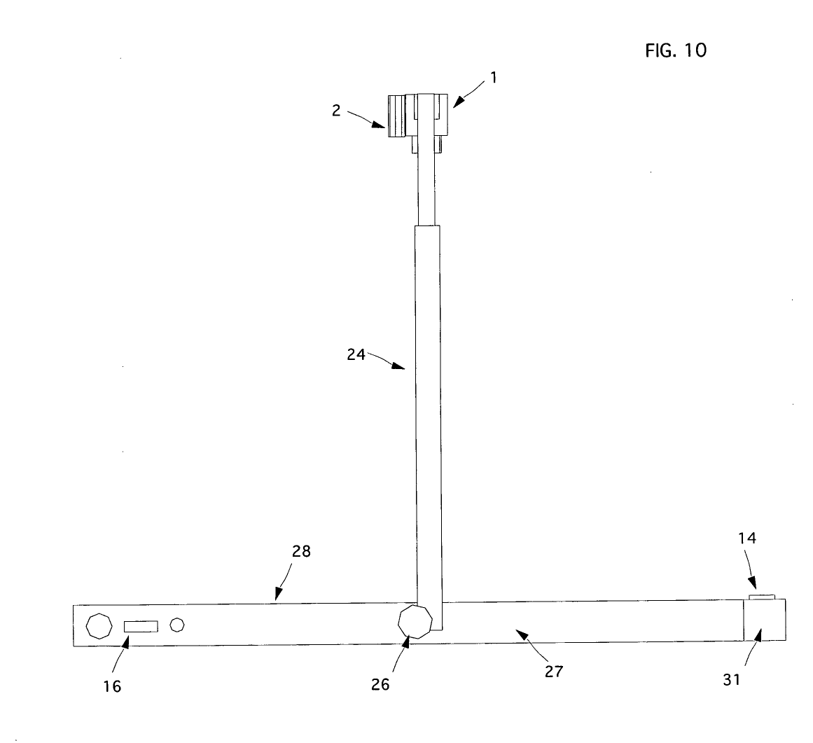

Hereinafter, a Digital Visual Presenter according to the first embodiment of the present invention will be explained with reference to FIGS. 1-10 FIG. 1 is a perspective view of a Portable Digital Visual Presenter in a using state, according to a first embodiment of the present invention. The Digital Visual Presenter includes a Digital Camera 1, a telescopic arm part 3, two lamps on arm 12, 13, and a housing 7, which are attached to one another so that each part can be folded to make the Digital Visual Presenter portable. The size thereof when collapsed is shown in FIG. 10. Attached to the digital camera 1 is a laser pointer 2 so that it can be seen where the centre of the digital camera's shooting area is located. The camera controls 14 are built-in in the control box 15, positioned in the left side of the housing 7, allowing the user to adjust the image settings such as zoom, focus, contrast, brightness and colour. The housing 7 has a sliding mechanism, generally indicated as 11, which slides over a low friction bottom 10, allowing the digital camera 1 to move along the y-axis and x-axis of the flat upper surface 8 (commonly called stage) so that the centre of the digital camera's shooting area reaches every sector of said stage 8.

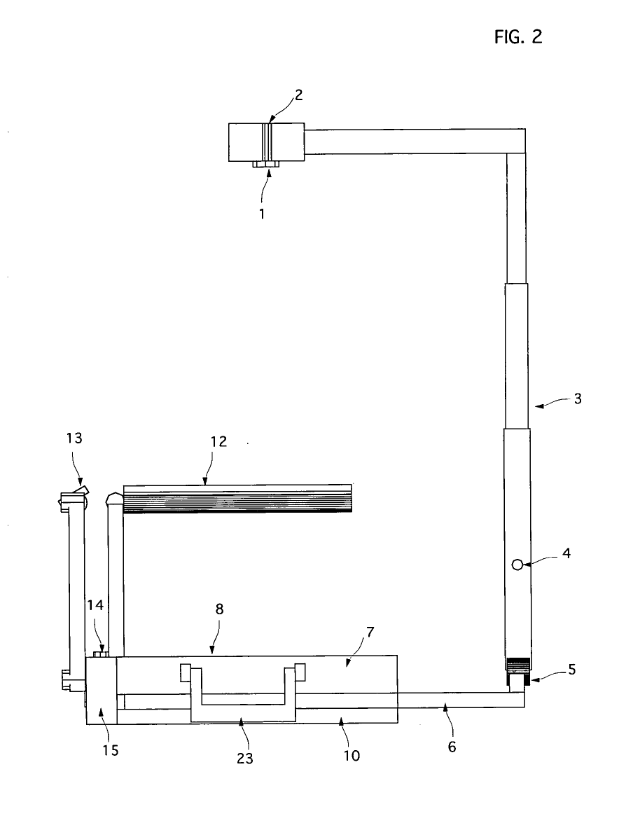

Referring now to FIG. 2 of the drawings, the numeral 15 indicates the control box located preferably in the left side of the housing. The numeral 5 indicates the hinge, which allows the camera to fold in the housing making the Digital Visual Presenter portable. A break release/laser on button 4 is included in the arm part. When the user presses the break release/laser on button 4, the sliding mechanism is free to move and a laser beam is projected onto the stage 8 so that allowing the user to know exactly where the centre of the digital camera's shooting area is located. The break release/laser on button 4 allows the user to handle the digital camera 1 easily and with a great precision. When the break release/laser on button 4 is not pressed, the sliding mechanism is locked, so as the digital camera 1, and the laser pointer 2 turned off in order to not influence the image being viewed.

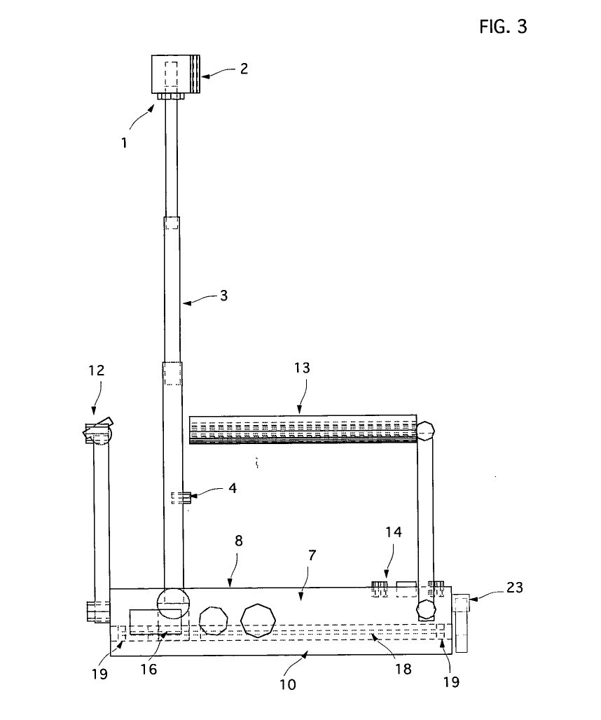

FIG. 3. is a transparent left side view of the Portable Digital Visual Presenter according to the first embodiment of the present invention, wherein the metal bar 18 and the input/output ports 16 are clearly shown.

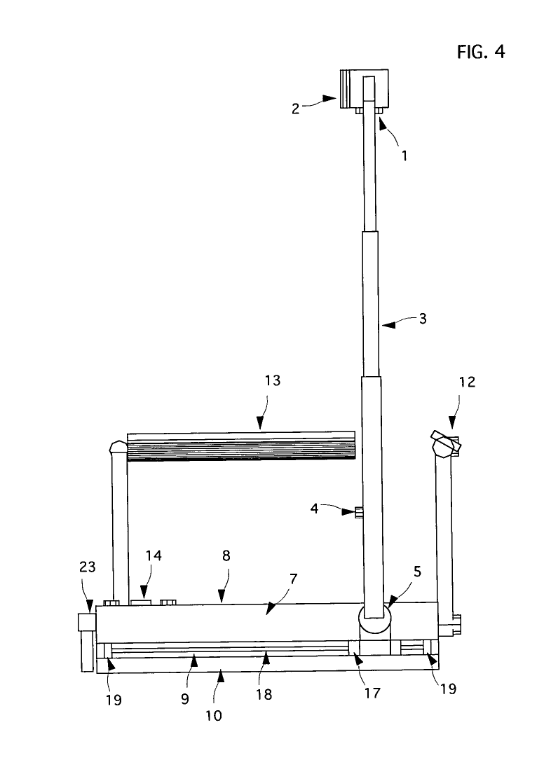

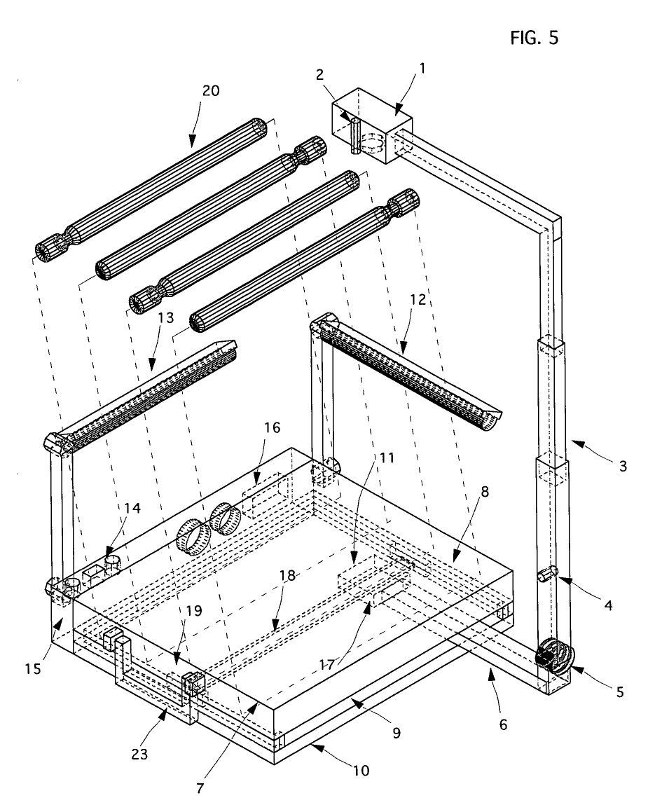

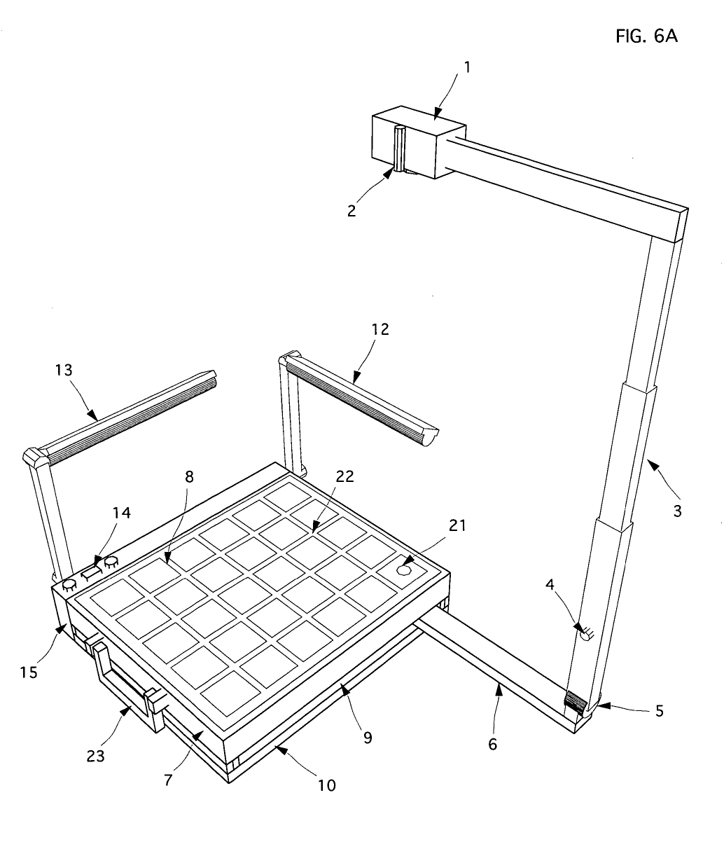

The housing's groove 9, wherein the metal bar 18 moves, and the sliding mechanism 11 are best shown in FIGS. 4 and 5. The sliding mechanism 11 works as follow: The telescopic arm part 3 is coupled by a hinge 5 to a lateral arm 6 that goes into the groove 9 parallel to the stage 8. A low friction sliding mounting 17 mounts the lateral arm 6 into the metal bar 18, which is also positioned in two low friction plastic square sliding bars 19. The sliding mechanism 11 slides over the low friction bottom 10 allowing the metal bar 18 to move in the horizontal axis of the housing 7 and the lateral arm 6 to move alongside the metal bar 18 in the vertical axis of the housing 7 so that the centre of the digital camera's shooting area reaches every sector of the stage 8. An important feature of the sliding mechanism 11 is that it keeps the digital camera 1 always in a plane parallel to the stage 8, not allowing the telescopic arm part 3 and the digital camera 1 to tilt, which would mean that the digital camera 1 takes deformed images. The back lighted stage 8 having a width of 410 mm and a length of 450 mm is designed to allow the 14×17 inches films 22, on which the MRI and CAT scans are commonly printed, to be adequately positioned on it. The light source comprises a set of halogen light bulbs 20, which are as thin as possible in order to make the Portable Digital Visual Presenter of this invention lighter and more portable. This light source is well known and is not the matter of the invention. Therefore, detailed description thereof is not necessary here.

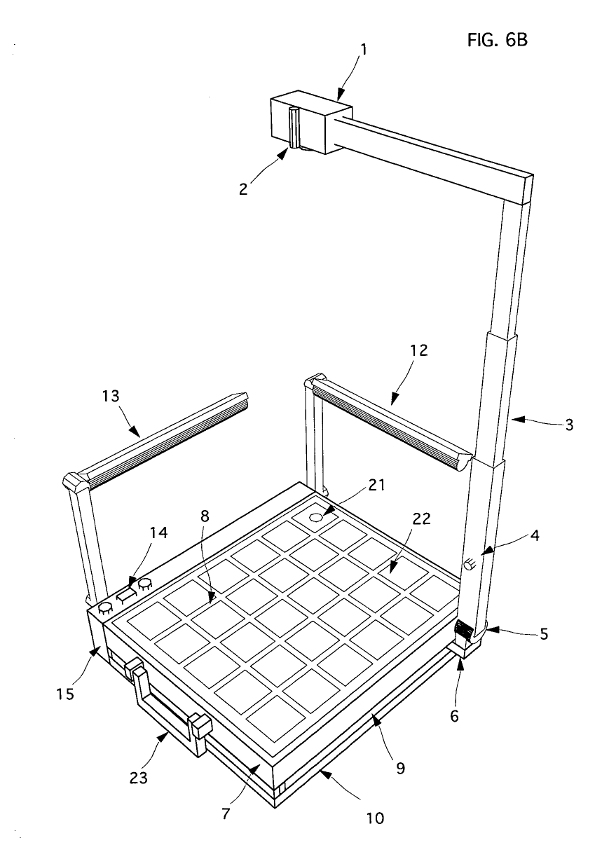

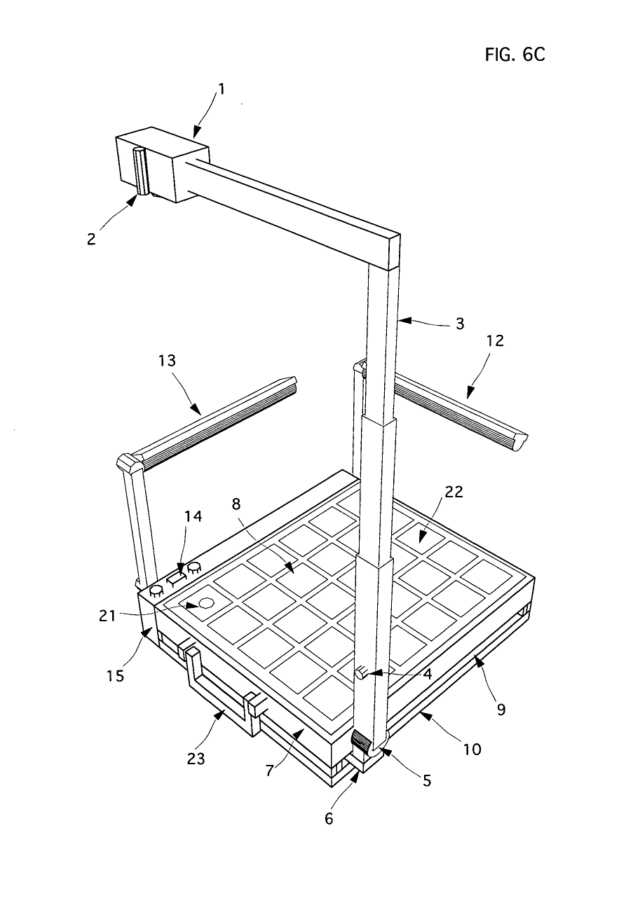

The first embodiment of the Portable Digital Visual Presenter of the present invention in a using state is best shown in FIG. 6A-6C of the drawings. The sliding mechanism 11 allows the digital camera 1 to move over the stage 8 so that the centre of the digital camera's shooting area reaches every sector of the said stage 8 as it is shown in the figures. The projection of the laser beam onto the stage 21 indicates the centre of the camera's shooting area position, allowing the user to know with high precision and in an easy way where the said centre is situated so that making the Portable Digital Visual Presenter's command more practical.

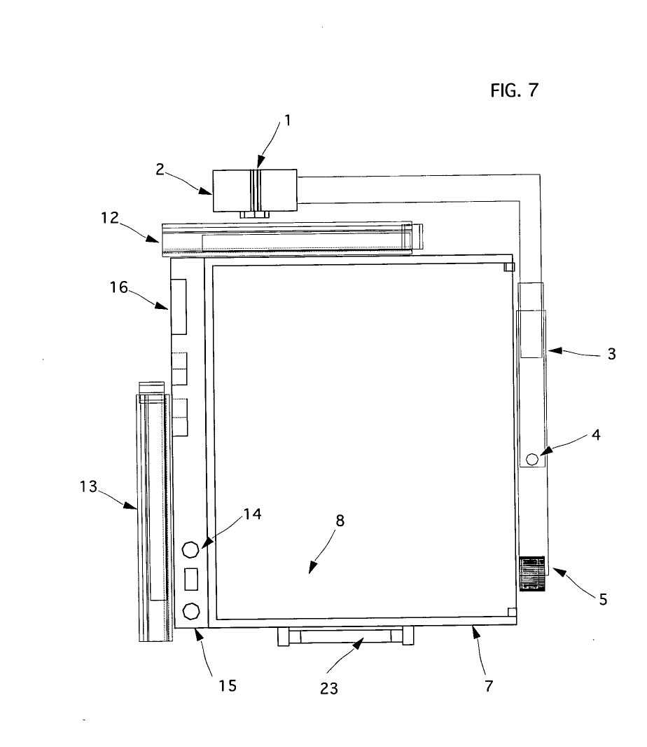

FIG. 7 is a top view of the first embodiment of the Portable Digital Visual Presenter in a collapsed state. The telescopic arm part 3 is compacted to its minimum size and swung on the housing 7, while the two lamps on arm 12, 13 are folded in its shaft first and in the said housing 7 after. It is clear from this picture that the first embodiment of the Portable Digital Visual Presenter of the present invention has an excellent portability. A handle 23 is provided to carry the collapsed Digital Visual Presenter.

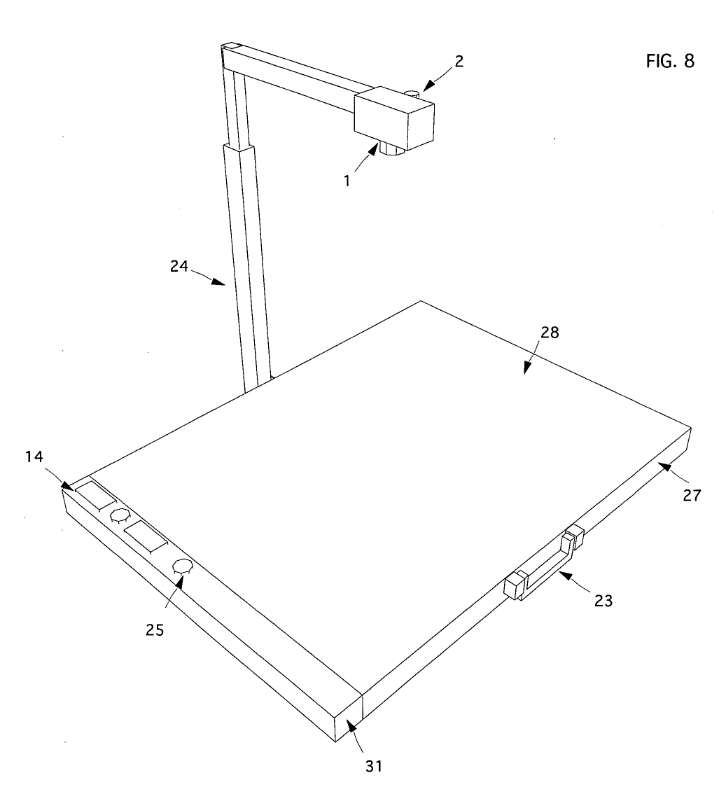

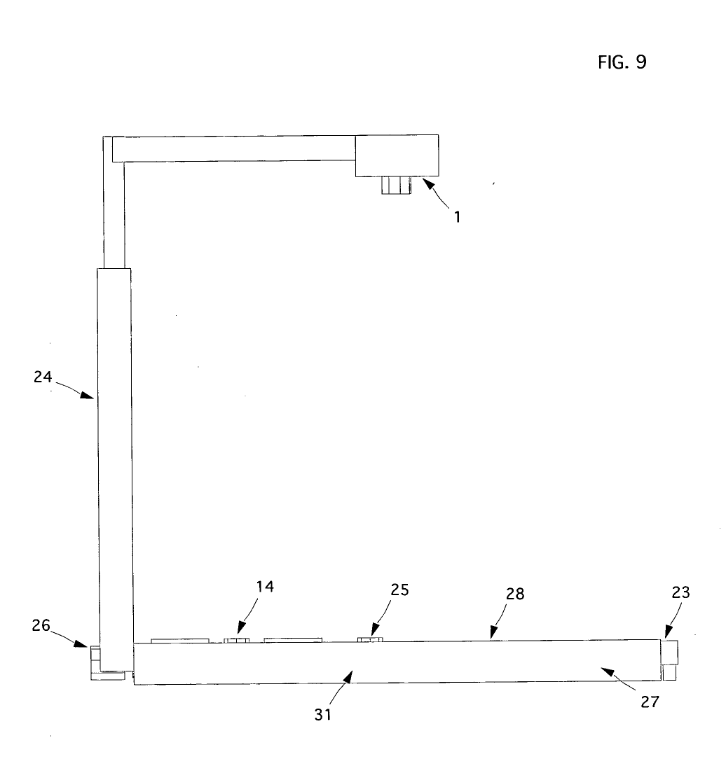

Next, a Digital Visual Presenter according to the second embodiment of the present invention will be explained with reference to FIGS. 8-12. In this case, the same numbers are attached to the portions corresponding to those of the first embodiment, and therefore an explanation for the portions is omitted.

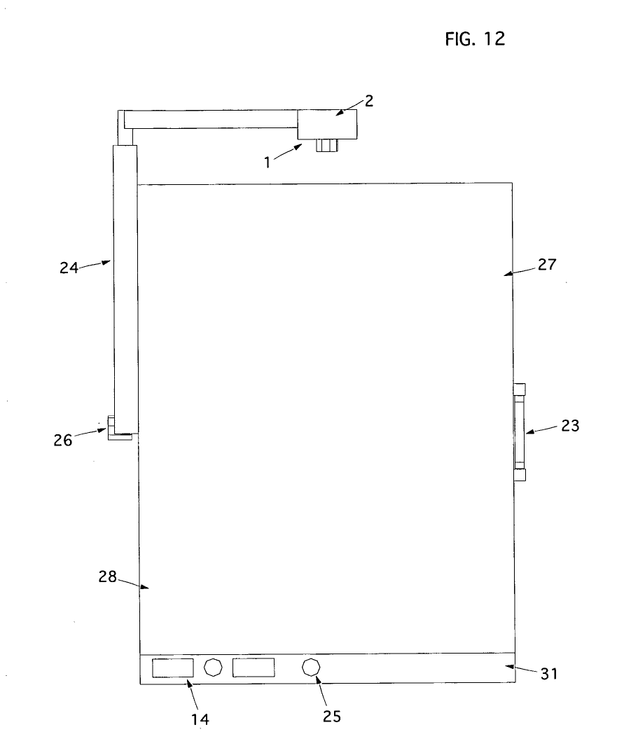

FIG. 8 is a perspective view of the Portable Digital Visual Presenter in a using state, according to the second embodiment of the present invention. The Portable Digital Visual Presenter comprises a digital camera 1, a telescopic arm part 24 and a housing 27, which are attached to one another so that each part can be folded to make the Digital Visual Presenter portable. The size thereof when collapsed is shown in FIG. 12. The camera controls 14 are built-in in the control box 31, located in the front side of the housing 27, allowing the user to adjust the image settings such as zoom, focus, contrast, brightness and colour. The telescopic arm part 24 to which the digital camera 1 is attached is fixed to the housing 27 so that the centre of the camera's shooting area is always the same. Attached to the digital camera 1 is a laser pointer 2 so that it can be seen exactly where the said centre is positioned.

Referring now to FIG. 9 of the drawings, the numeral 31 indicates the control box located preferably in the front side of the housing 27. The numeral 26 indicates the hinge, which allows the digital camera 1 to fold in the housing making the Digital Visual Presenter portable. A laser on button 25 is included in the control box 31. When the laser on button is pressed a laser beam 21 is projected onto the stage 28 so that allowing the user to know exactly the position of the digital camera's shooting area centre. When the laser on button 25 is released, the laser pointer 2 immediately turns off in order to not influence the image being viewed. The laser on button 25 makes the handle of the Portable Digital Visual Presenter easier and more practical.

FIG. 10. is a left side view of the Digital Visual Presenter according to the second embodiment of the present invention, wherein the input/output ports 16 can be clearly seen.

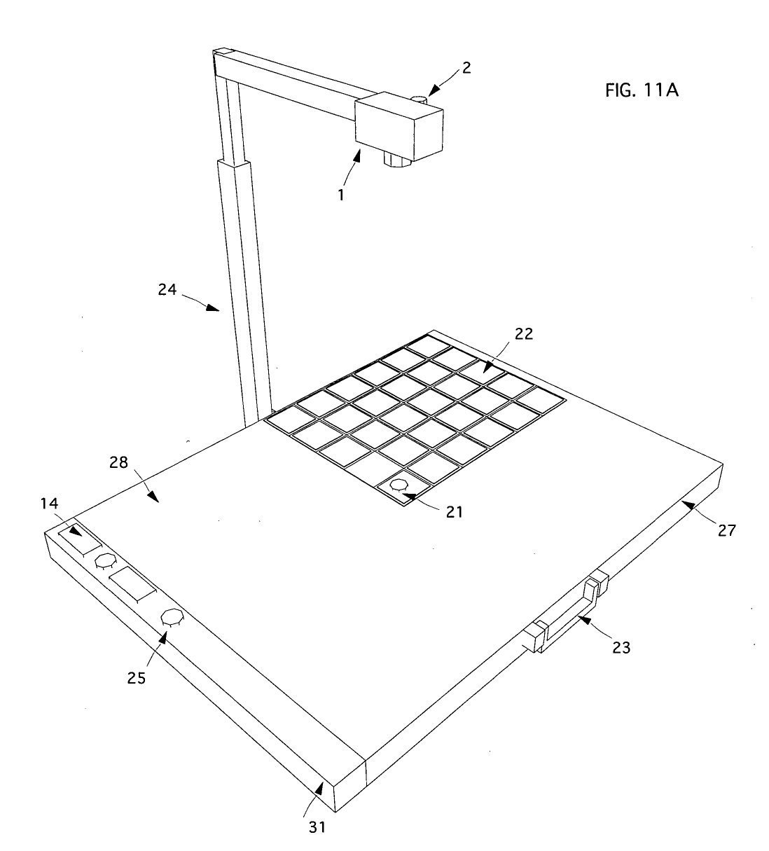

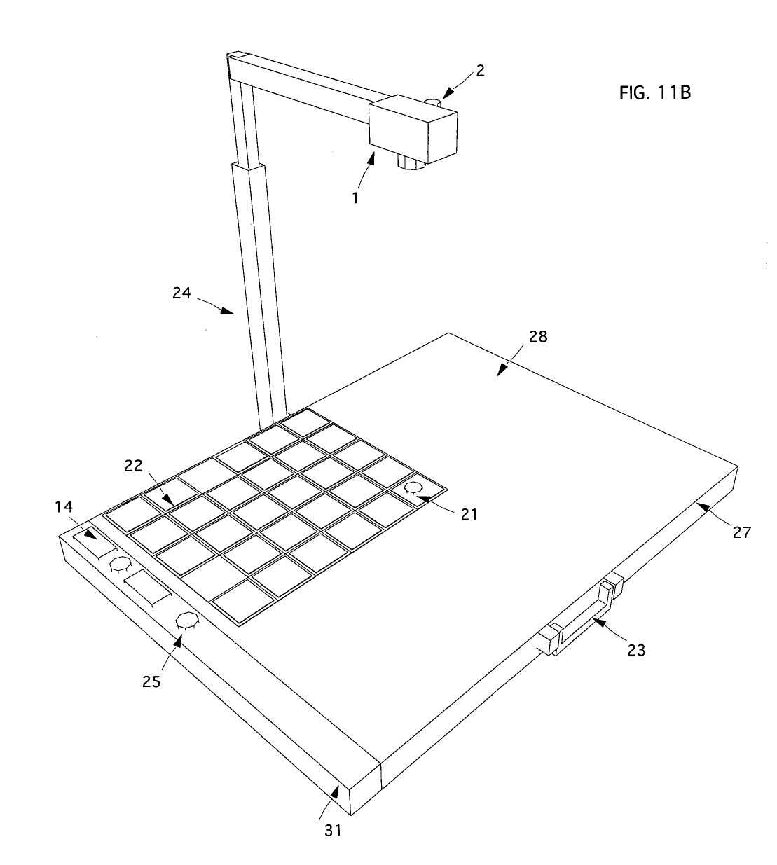

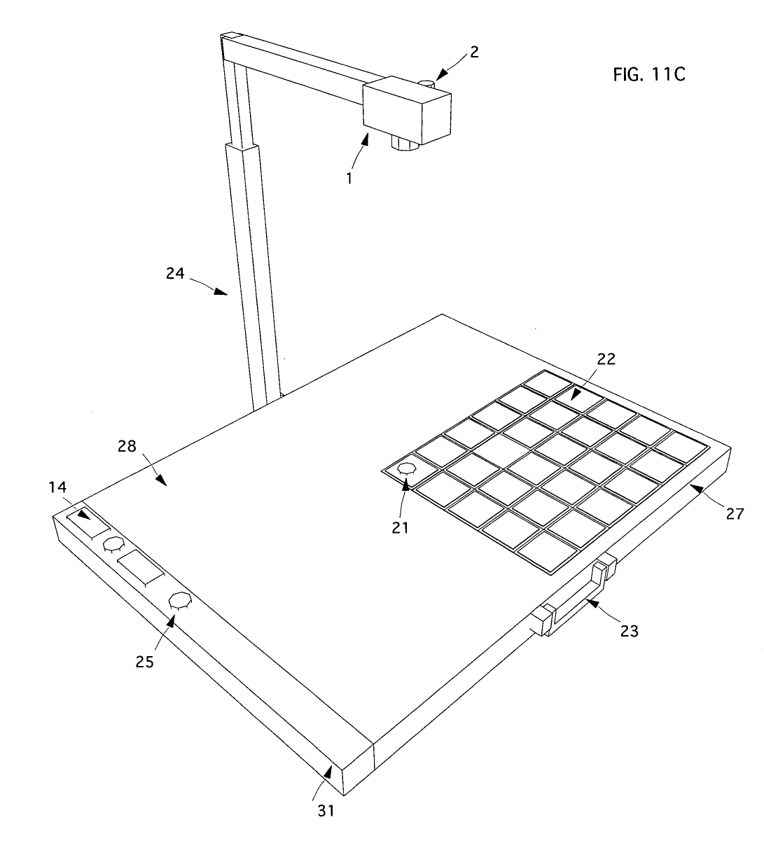

Referring now to FIGS. 11A-11C, it can be seen how the 14×17 inches film 22, on which the MRI and CAT scans are commonly printed, is slid over the stage 28 by the user in order to view the different individual images including on it. These pictures make noticeable how the user can manage to position each image of the said film in the centre of the camera shooting area, which is shown by the laser pointer's projection onto the stage 21, fulfilling the said camera shooting area so that the said individual image can be seen in full screen size when projected.

The collapsed Digital Visual Presenter is best shown in FIG. 12, wherein it is clear that the Portable Digital Visual Presenter according to a second embodiment of the present invention has an excellent portability. The telescopic arm part 24 is compacted to its minimum size and is swung on the housing 27. A handle 23 is provided to carry the collapsed Digital Visual Presenter.

It will be apparent from the foregoing description that the Digital Visual Presenter of this invention is highly advantageous for using with 14×17 inches films on which the MRI and CAT scans are commonly printed. I have overcome the disadvantages of conventional Digital Visual Presenter by providing a portable and easy to handle Digital Visual Presenter wherein the complete 14×17 films, on which the result of MRI and CAT scans are commonly printed, and each individual image on said film can be positioned at the centre of the digital camera's shooting area, fulfilling the said shooting area. Therefore, said images can be projected in full screen size onto a screen or wall when the Portable Digital Visual Presenter of the present invention is used in conjunction with a data/video projector.

While 1 have illustrated and described two preferred embodiments of the invention, it will be understood that those skilled in the art will thereby be enabled to devise variations and modifications without departing from the spirit and scope of this invention, as defined in the appended claims. For example, the Portable Digital Visual Presenter according to the first and second embodiment presented could be adapted to work in a vertical plan instead of a horizontal one.

1. A Portable Digital Visual Presenter comprising:
a) a special design in order to be used with 14×17 inches films on which the result of MRI and CAT scan are commonly printed;
b) a digital camera's shooting area of at least 14×17 inches;
c) wherein the position of the film with respect to the digital camera is variable in order to allow each individual image to be situated in the centre of the digital camera's shooting area, fulfilling the said camera's shooting area.

2. A Portable Digital Visual Presenter as claimed in claim 1 wherein the digital camera is attached to a sliding mechanism so that the centre of the shooting area of the camera reaches every sector of the flat upper surface.

3. A Portable Digital Visual Presenter as claimed in claim 1 wherein the housing is big enough to allow the film to slide over the stage so that each image included in the 14×17 film can be positioned exactly at the centre of the shooting area of the camera.

4. A Portable Digital Visual Presenter as claimed in claim 1, wherein a laser pointer is attached to the camera in order to show exactly where in the flat upper surface the centre of the shooting area of the camera is positioned.

5. A Portable Digital Visual Presenter as claimed in claim 2, wherein said sliding mechanism is motor driven.
